(19) United States
(12) Patent Application Publication
(10) Pub. No.: US 2010/0232766 A1
(43) Pub. Date: Sep. 16, 2010

(54) REPRODUCTION DEVICE, REPRODUCTION METHOD, AND COMPUTER PROGRAM PRODUCT

(75) Inventors: Mitsuru Kubota, Matsumoto-shi (JP); Kyosuke Itahana, Matsumoto-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/720,851

(22) Filed: Mar. 10, 2010

(30) Foreign Application Priority Data
Mar. 11, 2009 (JP) 2009-058286

(51) Int. Cl. H04N 5/91

(52) U.S. Cl. 386/96; 386/69; 386/E05.003

(57) ABSTRACT

A reproduction device includes: a reproduction unit which reproduces audio and/or video data; a reproduction position display unit which displays a time axis and scales on the time axis and displays a reproduction position indicator indicating the current reproduction position of the audio and/or video data on the time axis; an operation unit which receives operation for shifting the reproduction position indicator on the time axis; and a shift information detection unit which detects information concerning to shift received by the operation unit, wherein the reproduction unit reproduces audio and/or video data at the reproduction position indicated by the reproduction position indicator after shift when operation for shifting the reproduction position indicator is received by the operation unit, and the reproduction position display unit changes time interval shown by a unit length between the scales on the time axis based on the shift information.

### CROSS-REFERENCE

The present application claims priority from Japanese Patent Application No. 2009-058286 filed on Mar. 11, 2009, which is hereby incorporated by reference in its entirety.

### BACKGROUND

A known audio or video reproduction device for reproducing audio data or video data (hereinafter referred to as “audio or video data”) changes reproduction position by operation of a fast-forward button or a rewind button. According to this method, reproduction speed increases in response to press of the button by the user, thereby changing the reproduction position to an arbitrary position at higher speed than that at the time of ordinary reproduction.

According to another method currently proposed, seek bar is used for changing the reproduction position. The seek bar is a function of displaying the reproduction position of audio or video data. More specifically, the seek bar includes a bar representing time axis from the beginning to the end of the audio or video data being reproduced, and a slider showing current reproduction position, and indicates the current reproduction position as the indication position of the slider on the bar. By shifting the indication position of the slider, the user can change the reproduction position to an arbitrary position at a speed higher than that by press of the fast-forward button or rewind button (see Japanese Patent Publication No. 2004-96474).

According to the method using the fast-forward button and rewind button, a long time is required for shifting the reproduction position to an arbitrary position when the time difference between the current reproduction position and the reproduction position after shifting is large. According to the method using the seek bar, the reproduction position is shifted by several minutes in response to slight shift operation of the slider in case of long reproduction time data, which makes it difficult to change the reproduction position to the arbitrary position with accuracy.

### SUMMARY

Various embodiments may provide a reproduction device, a reproduction method, and a computer program product capable of specifying a reproduction position of audio or video data more accurately.

A reproduction device according to at least one embodiment of the disclosure includes: a reproduction unit which reproduces audio and/or video data; a reproduction position display unit which displays a time axis and scales on the time axis to display a reproduction position indicator indicating the current reproduction position of the audio and/or video data on the time axis; an operation unit which receives operation for shifting the reproduction position indicator on the time axis; and a shift information detection unit which detects information about shift received by the operation unit. The reproduction unit reproduces audio and/or video data at the reproduction position corresponding to the position of the reproduction position indicator after shift when operation for shifting the reproduction position indicator is received by the operation unit. The reproduction position display unit changes time interval shown by a unit length between the scales on the time axis based on the shift information.

It is preferable that the shift information shows a shift speed of the reproduction position indicator in the reproduction device described above. When the shift information is lower than a predetermined threshold, the reproduction position display unit displays a period corresponding to a predetermined width containing the reproduction position indicated by the reproduction position indicator at that timing such that the distance between the scales becomes longer than the corresponding distance currently displayed comparing the same time interval.

According to at least one embodiment of the disclosure, there is provided a reproduction method performed by an information processing device constituted by the reproduction device described above, and to a computer program under which an information processing device operates as the reproduction device described above.

According to these embodiments, the interval of the scales on the time axis is changed before display according to the information about the shift of the reproduction position indicator. Thus, the user can specify the reproduction position of the audio and/or video data more accurately.

### BRIEF DESCRIPTION OF THE DRAWINGS

Non-limiting and non-exhaustive embodiments of the present disclosure will be described with reference to the accompanying drawings, wherein like reference numbers reference like elements.

FIG. 1 is a block diagram schematically showing a function structure of a reproduction device.

FIG. 2 illustrates a specific example of display provided by a reproduction unit and a reproduction position display unit.

FIG. 3 is a flowchart showing operation of the reproduction device.

FIG. 4 illustrates a specific example of scales displayed by the reproduction position display unit according to first expansion setting.

FIG. 5 illustrates a specific example of scales displayed by the reproduction position display unit according to second expansion setting.

FIG. 6 illustrates a specific example of first expansion setting and second expansion setting of a reproduction device according to a modified example.

FIG. 7 illustrates a specific example of first expansion setting and second expansion setting of a reproduction device according to another modified example.

### DESCRIPTION OF EMBODIMENT

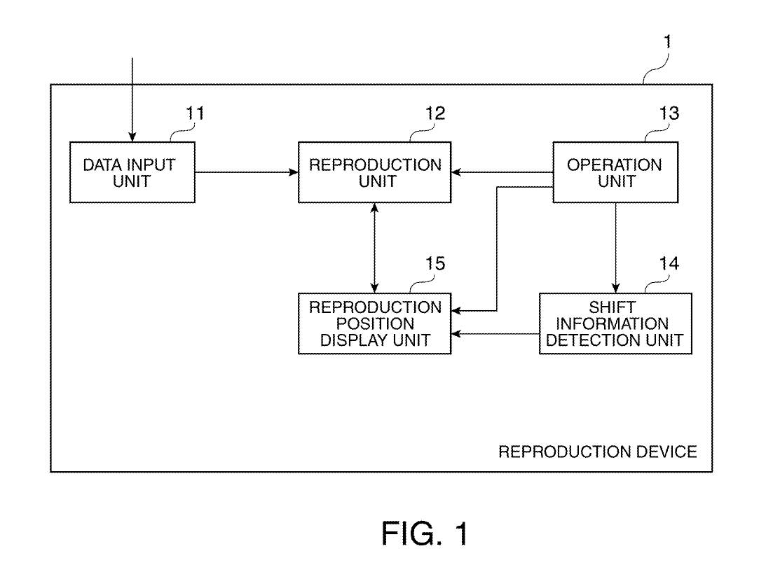

FIG. 1 is a block diagram schematically showing a function structure of a reproduction device 1. The reproduction device 1 includes a data input unit 11, a reproduction unit 12, an operation unit 13, a shift information detection unit 14, and a reproduction position display unit 15. The reproduction device 1 has an information processing device containing CPU (central processing unit), main memory and the like connected with one another via buses, and operates as a device equipped with the respective function units under a computer program stored in the main memory performed by the CPU.

The data input unit 11 inputs audio data or video data (these two types of data are hereinafter collectively referred to as “audio or video data”) to the reproduction device 1. The data input unit 11 may input data by receiving audio or video data from other device via network, by reading audio or video data from a recording medium such as CD (compact disk), DVD (digital versatile disc), and semiconductor memory unit, or by other known methods.

The reproduction unit 12 reproduces audio or video data inputted from the data input unit 11.

The operation unit 13 receives an input signal produced in response to operation of an input device such as mouse and keyboard by the user as operation for shifting a reproduction position indicator 163 described later.

The shift information detection unit 14 detects information about shift of the reproduction position indicator 163 received by the operation unit 13 (hereinafter referred to as “shift information”). The shift information includes shift speed of the reproduction position indicator 163 (shift amount per unit time), the indication position of the reproduction position indicator 163 after shift, and other information.

The reproduction position display unit 15 displays time axis 161 showing the reproduction position, scales 162 of the time axis, and the reproduction position indicator 163. The details of process performed by the reproduction position display unit 15 will be described later.

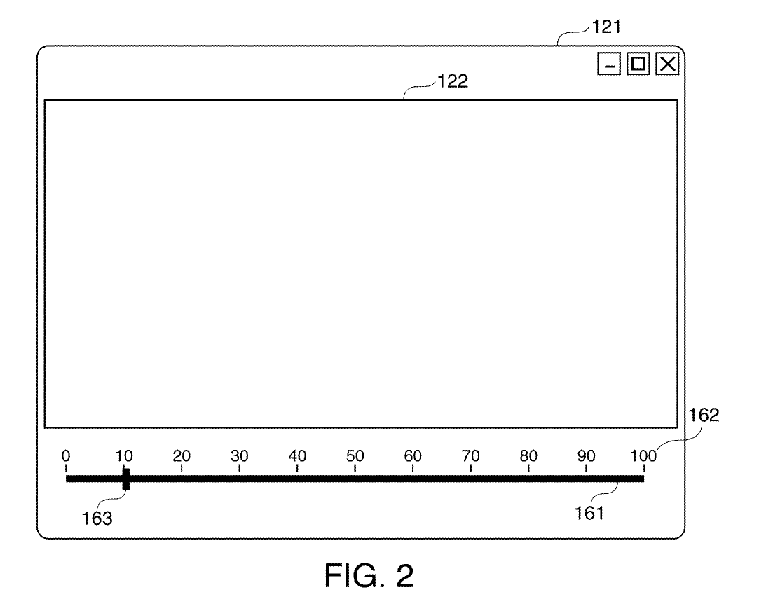

FIG. 2 illustrates a specific example of display provided by the reproduction unit 12 and the reproduction position display unit 15. For reproducing audio data, the reproduction unit 12 displays a specific image or the like within a display frame 122 inside a window 121 displayed by an image display device, and reproduces audio from a speaker. For reproducing video data, the reproduction unit 12 reproduces and displays a video within the display frame 122 inside the window 121 displayed by the image display device, and reproduces audio from the speaker with reproduction of the video when the video accompanies audio. The image display device used herein is a projector, a CRT (cathode ray tube), a liquid crystal display, or other devices.

The reproduction position display unit 15 displays the time axis 161, the scales 162, and the reproduction position indicator 163 inside the window 121 displayed by the image display device. The time axis 161 has a length corresponding to the horizontal width of the window 121 as an axis showing the reproduction position. The scales 162 indicate specific reproduction positions (times) of audio or video data corresponding to predetermined positions on the time axis 161. According to the example shown in FIG. 2, the total reproduction time of the audio or video data being reproduced is 100 minutes, and the reproduction position display unit 15 displays the scales 162 for every 10 minutes above the time axis 161. The reproduction position indicator 163 is displayed at the current reproduction position of the audio or video data reproduced by the reproduction unit 12 on the time axis 161. For example, when the reproduction position indicator 163 is displayed at the position to which “10” of the scales 162 is given, it is indicated that the contents to be reproduced at the time after elapse of 10 minutes from the reproduction start are being reproduced by the reproduction unit 12 under the condition of reproduction of audio or video data at normal reproduction speed.

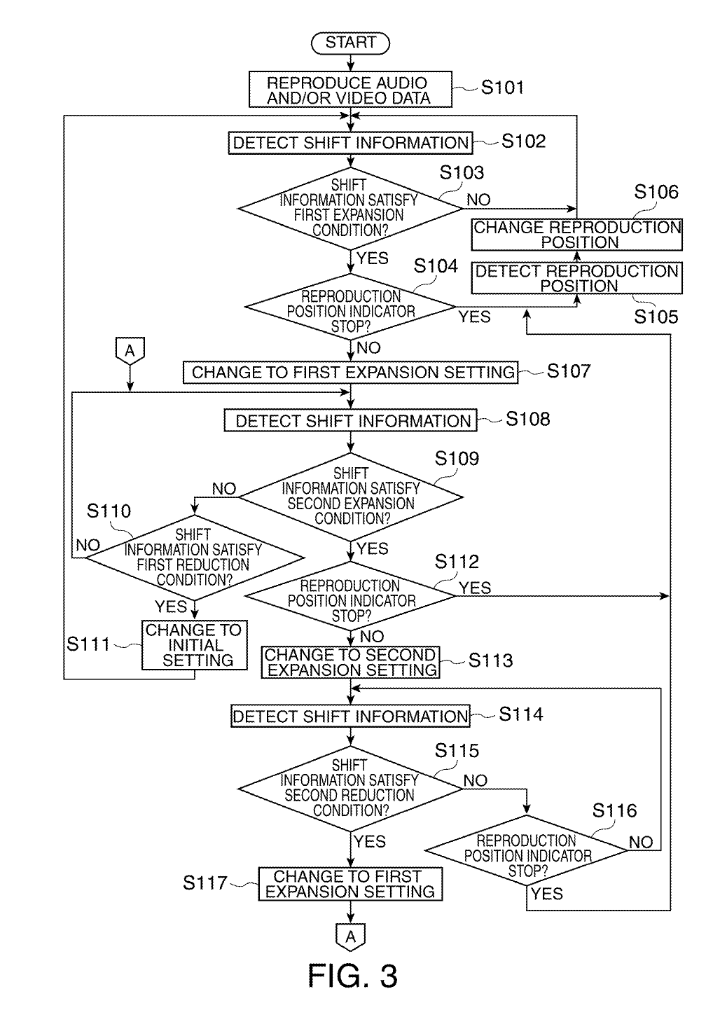

FIG. 3 is a flowchart showing operation of the reproduction device 1. An example of the operation of the reproduction device 1 is now explained. Initially, the data input unit 11 inputs audio or video data, and the reproduction unit 12 reproduces the audio or video data (step S101). With reproduction start of the audio or video data, the reproduction position display unit 15 displays the time axis 161 and the scales 162 according to initial setting, and displays the reproduction position indicator 163 at the current reproduction position. The initial setting herein refers to setting concerning intervals of the scales 162 displayed in advance before the operation unit 13 receives operation for shifting the reproduction position indicator 163. According to the example shown in FIG. 2 which has the scale 162 at one end of the time axis 161 representing the reproduction start time (0 minute) and the scale 162 at the other end representing the reproduction end time, the respective numerals of the scales 162 are provided at equal intervals.

The shift information detection unit 14 periodically monitors the operation unit 13 after reproduction of the audio or video data to detect shift information (step S102). When the shift information detection unit 14 detects shift information, the reproduction position display unit 15 determines whether shift information satisfies first expansion condition (step S103). The first expansion condition is condition for determining whether to change the display of the scales 162 from the initial setting to first expansion setting. For example, the reproduction position display unit 15 determines that the first expansion condition is satisfied when shift speed of the reproduction position indicator 163 received by the operation unit 13 is lower than a predetermined threshold.

When the shift information does not satisfy the first expansion condition (step S103: NO), the processes in step S102 and step S103 are repeated. When the shift information satisfies the first expansion condition (step S103: YES), the reproduction position display unit 15 determines whether the reproduction position indicator 163 has been stopped (whether the operation unit 13 has finished shift operation of the reproduction position indicator 163) (step S104).

When it is determined that the reproduction position indicator 163 has stopped (step S104: YES), the reproduction position display unit 15 detects the reproduction position corresponding to the indication position at which the reproduction position indicator 163 has stopped on the time axis 161 (step S105) and notifies the reproduction unit 12 about the detected reproduction position. Then, the reproduction unit 12 changes the reproduction position of the audio or video data being reproduced based on the notified reproduction position (step S106) and repeats the processes after step S102. When the reproduction position indicator 163 does not stop (step S104: NO), the reproduction position display unit 15 changes the setting of the intervals of the scales 162 from the initial setting to the first expansion setting (step S107).

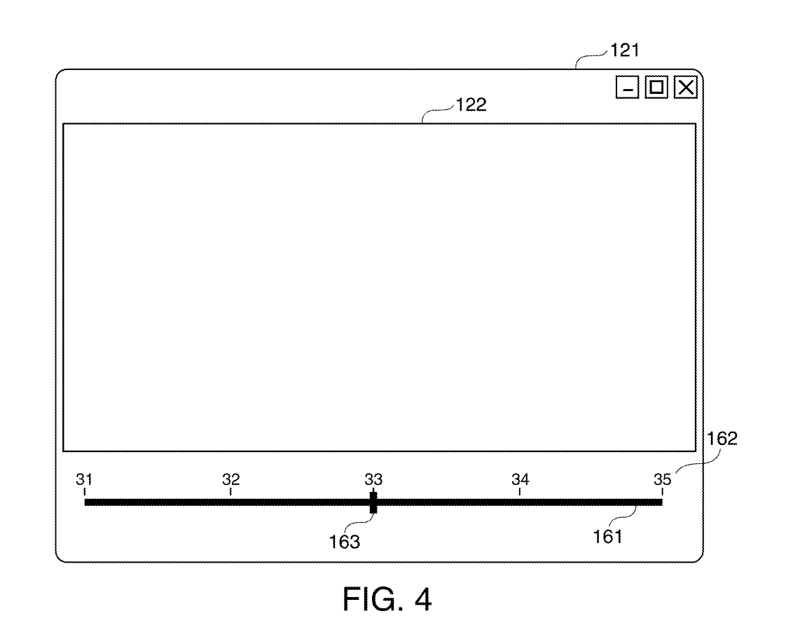

FIG. 4 shows a specific example of the scales 162 displayed by the reproduction position display unit 15 according to the first expansion setting. In the first expansion setting, a part of the time displayed in the initial setting is expanded such that the distance between the scales for the unit time becomes longer than the corresponding distance in the initial setting. For example, when the example shown in FIG. 2 corresponds to the specific display in the initial setting, the scales 162 show the period from 0 to 100 minutes in the initial setting. However, according to the first expansion setting in FIG. 4, the scales 162 show only the period from 31 to 35 minutes as expanded part. Thus, comparing the same time interval, the distance between the scales becomes longer in the first expansion setting than the corresponding distance in the initial setting.

When the setting of the intervals of the scales 162 is changed to the first expansion setting in step S107, the reproduction position display unit 15 displays the scales for a predetermined period before and after the time corresponding to the reproduction position at which the reproduction position indicator 163 is located at that time (the period of two minutes before and after the position of the reproduction position indicator 163 in the example shown in FIG. 4). In this case, the reproduction position display unit 15 shifts the indication position of the reproduction position indicator 163 according to the scales 162 after the change to the first expansion setting.

Returning to FIG. 3, explanation of the operation of the reproduction device 1 is continued. When the setting of the intervals of the scales 162 is changed to the first expansion setting, the shift information detection unit 14 periodically monitors the operation unit 13 and detects shift information (step S108). When the shift information detection unit 14 detects shift information, the reproduction position display unit 15 determines whether shift information satisfies second expansion condition (step S109). The second expansion condition is condition for determining whether to change the display of the scales 162 from the first expansion setting to second expansion setting. For example, the reproduction position display unit 15 determines that the second expansion condition is satisfied when shift speed of the reproduction position indicator 163 received by the operation unit 13 is lower than a predetermined threshold.

When the shift information does not satisfy the second expansion condition (step S109: NO), the reproduction position display unit 15 determines whether the shift information satisfies first reduction condition (step S110). The first reduction condition is condition for determining whether to change the display of the scales 162 from the first expansion setting to the initial setting. For example, the reproduction position display unit 15 may determine that the first reduction condition is satisfied when the shift speed of the reproduction position indicator 163 received by the operation unit 13 is higher than a predetermined threshold, or when the indication position of the reproduction position indicator 163 reaches one end or the other end of the time axis 161. When the first reduction condition is not satisfied (step S110: NO), the processes after step S108 are repeated. When the first reduction condition is satisfied (step S110: YES), the reproduction position display unit 15 changes the setting of the intervals of the scales 162 from the first expansion setting to the initial setting (step S111) and repeats the processes after step S102.

When the setting of the intervals of the scales 162 is changed to the initial setting in step S111, the reproduction position display unit 15 shifts the indication position of the reproduction position indicator 163 according to the scales 162 after the change to the initial setting.

Returning to the explanation of the process in step 5109, the reproduction position display unit 15 determines whether the reproduction position indicator 163 has stopped (step S112) when the shift information satisfies the second expansion condition (step S109: YES). When it is determined that the reproduction position indicator 163 has stopped (step 5112: YES), the reproduction position display unit 15 detects the reproduction position corresponding to the indication position at which the reproduction position indicator 163 has stopped on the time axis 161 (step S105) and notifies the reproduction unit 12 about the detected reproduction position. Then, the reproduction unit 12 changes the reproduction position of the audio or video data being reproduced based on the notified reproduction position (step S106) and repeats the processes after step S102. When the reproduction position indicator 163 does not stop (step S112: NO), the reproduction position display unit 15 changes the setting of the intervals of the scales 162 from the first expansion setting to the second expansion setting (step S113).

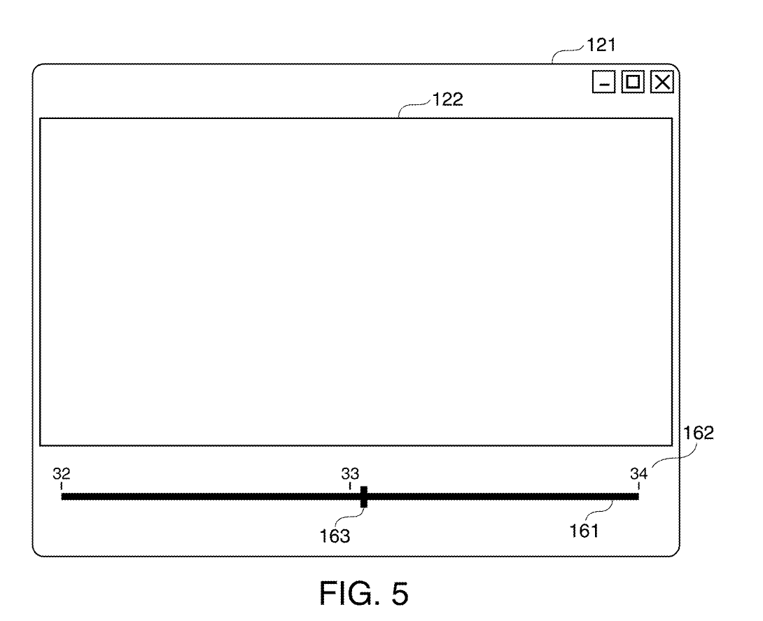

FIG. 5 illustrates a specific example of the scales 162 displayed by the reproduction position display unit 15 according to the second expansion setting. In the second expansion setting, a part of the time displayed in the first expansion setting is expanded such that the distance between the scales for unit time becomes longer than the corresponding distance in the first expansion setting. For example, while the part of the scales 162 from 31 to 35 minutes are displayed in the first expansion setting in FIG. 4, only the part of the scales 162 from 32 to 34 minutes are shown in the second expansion setting in FIG. 5. Thus, comparing the same time interval, the distance between the scales becomes longer in the second expansion setting than the corresponding distance in the first expansion setting.

When the setting of the intervals of the scales 162 is changed to the second expansion setting in step S113, the reproduction position display unit 15 displays the scales for a predetermined period before and after the time corresponding to the reproduction position at which the reproduction position indicator 163 is located at that time (the period of one minute before and after the position of the reproduction position indicator 163 in the example shown in FIG. 5). In this case, the reproduction position display unit 15 shifts the indication position of the reproduction position indicator 163 according to the scales 162 after the change to the second expansion setting.

Returning to FIG. 3, explanation of the operation of the reproduction device 1 is continued. When the setting of the intervals of the scales 162 is changed to the second expansion setting, the shift information detection unit 14 periodically monitors the operation unit 13 and detects shift information (step S114). When the shift information detection unit 14 detects shift information, the reproduction position display unit 15 determines whether shift information satisfies second reduction condition (step S115). The second reduction condition is condition for determining whether to change the display of the scales 162 from the second expansion setting to the first expansion setting. For example, the reproduction position display unit 15 may determine that the second reduction condition is satisfied when the shift speed of the reproduction position indicator 163 received by the operation unit 13 is higher than a predetermined threshold, or when the indication position of the reproduction position indicator 163 reaches one end or the other end of the time axis 161.

When the second reduction condition is not satisfied (step S115: NO), the reproduction position display unit 15 determines whether the reproduction position indicator 163 has stopped (step S116). When it is determined that the reproduction position indicator 163 has stopped (step S116: YES), the reproduction position display unit 15 detects the reproduction position corresponding to the indication position at which the reproduction position indicator 163 has stopped on the time axis 161 (step S105) and notifies the reproduction unit 12 about the detected reproduction position. Then, the reproduction unit 12 changes the reproduction position of the audio or video data being reproduced based on the notified reproduction position (step S106) and repeats the processes after step S102.

When the reproduction position indicator 163 does not stop (step S116: NO), the processes after step S114 are repeated. Returning to the process in step S115, the reproduction position display unit 15 changes the setting of the intervals of the scales 162 from the second expansion setting to the first expansion setting (step S117) and repeats the processes after step S108 when the second reduction condition is satisfied (step S115: YES).

When the setting of the intervals of the scales 162 is changed to the first expansion setting in step S117, the reproduction position display unit 15 may display the scales for a predetermined period before and after the central time of the scales 162 (33 minutes in the example shown in FIG. 5) displayed at the intervals according to the second expansion setting (in the example shown in FIG. 4, the predetermined period is two minutes before and after the central time). Alternatively, the reproduction position display unit 15 may display the scales for a predetermined period before and after the time corresponding to the reproduction position at which the reproduction position indicator 163 is located immediately before step S117, for example (in the example shown in FIG. 4, the predetermined period is two minutes before and after the position of the reproduction position indicator 163). In either case, the reproduction position display unit 15 shifts the indication position of the reproduction position indicator 163 according to the scales 162 after the change to the first expansion setting.

Accordingly, when the first expansion condition or the second expansion condition of the reproduction device 1 having this structure is satisfied, the distance between the scales is expanded from the distance between the scales currently displayed comparing the same time interval. Thus, detailed time for the reproduction position can be easily specified by shifting the reproduction position indicator 163, and the reproduction position of the audio or video data can be more precisely specified. On the other hand, when the first reduction condition or the second reduction condition is satisfied, the distance between the scales is reduced from the distance between the scales currently displayed comparing the same time interval. Thus, the reproduction position can be moved for a long distance up to a time not displayed by the scales 162 in the first expansion setting or the second expansion setting.

### Modified Example

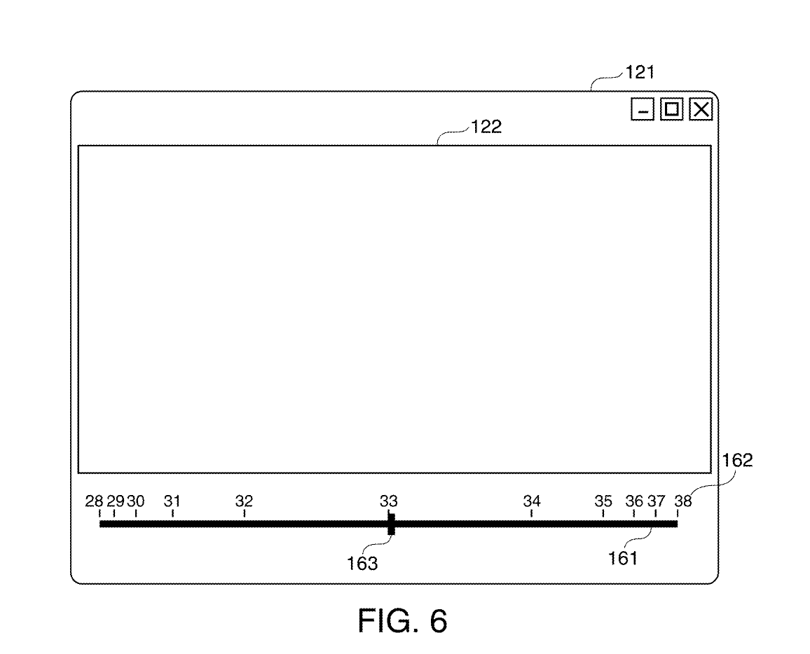

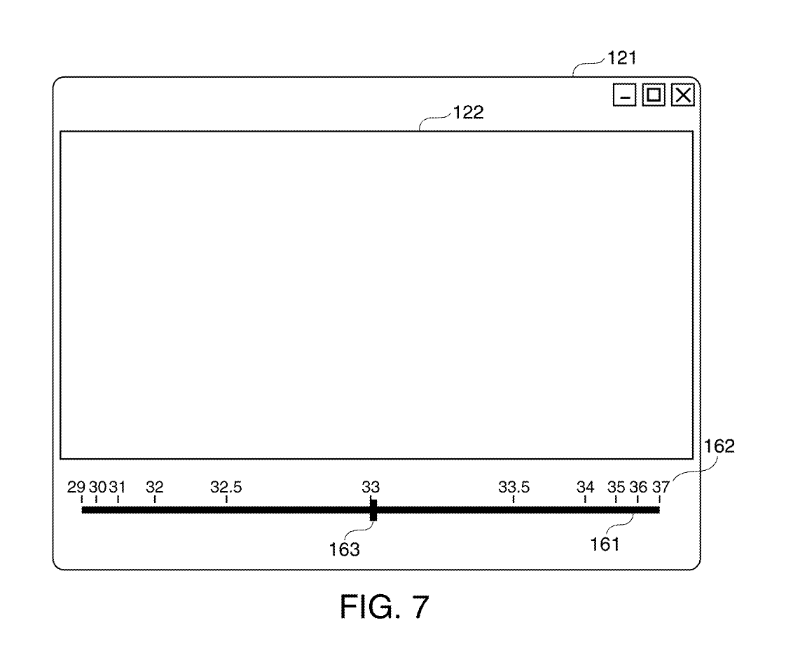

FIGS. 6 and 7 show specific examples of first expansion setting and second expansion setting according to modified examples of the reproduction device 1. The reproduction position display unit 15 may display not scales having linear intervals (scales shown in FIGS. 2, 4 and 5) but scales having non-linear intervals. In this case, the reproduction position display unit 15 displays scales such that the distances between the respective scales showing equal time intervals decrease as located closer to the end of the time axis 161, and increase as located closer to the center of the time axis 161. According to the example shown in FIG. 6, the reproduction position display unit 15 displays the period from 28 to 38 minutes as expanded part, and the distance between the scales corresponding to 28 minutes and 29 minutes is shorter than the distance between the scales corresponding to 32 minutes and 33 minutes closer to the center though these distances show the same time interval of 1 minute. Alternatively, the reproduction position display unit 15 may display scales having decimals as illustrated in FIG. 7. By displaying these scales, the time of reproduction position at which the reproduction position indicator 163 is located immediately before the change of the interval setting of the scales 162, that is, the part at which the user desires to specify the detailed reproduction position with high probability can be further expanded than another part to display a long distance between the scales for each unit time. Accordingly, the user can easily specify the desired reproduction position.

The reproduction device 1 may include a memory unit for storing audio or video data inputted from the data input unit 11 such that the reproduction unit 12 can reproduce audio or video data stored in the memory unit. The first expansion condition and the second expansion condition may be the same condition or different conditions. Similarly, the first reduction condition and the second reduction condition may be the same condition or different conditions.

While the embodiment of the invention has been described in detail with reference to the drawings, particular structures and constitutions are not limited to those of the embodiment shown herein but may include other designs and the like without departing from the scope of the invention.

What is claimed is:

1. A reproduction device comprising:
a reproduction unit which reproduces audio and/or video data;
a reproduction position display unit which displays a time axis and scales on the time axis and displays a reproduction position indicator indicating the current reproduction position of the audio and/or video data on the time axis;
an operation unit which receives operation for shifting the reproduction position indicator on the time axis; and
a shift information detection unit which detects information concerning to shift received by the operation unit,
wherein
the reproduction unit reproduces audio and/or video data at the reproduction position indicated by the reproduction position indicator after shift in case that operation for shifting the reproduction position indicator is received by the operation unit, and
the reproduction position display unit changes time interval shown by a unit length between the scales on the time axis based on the shift information.

2. The reproduction device according to claim 1, wherein:
the shift information shows a shift speed of the reproduction position indicator; and
in case that the shift information is lower than a predetermined threshold, the reproduction position display unit changes the distance between the scales to become longer than the corresponding distance currently displayed comparing the same time interval.

3. The reproduction device according to claim 1, wherein:
the shift information shows a shift speed of the reproduction position indicator; and
when the shift information is higher than a predetermined threshold, the reproduction position display unit changes the distance between the scales to become shorter than the corresponding distance currently displayed comparing the same time interval.

4. The reproduction device according to claim 1, wherein the reproduction position display unit displays scales having non-linear intervals.

5. The reproduction device according to claim 4, wherein the reproduction position display unit displays scales such that the distances between the respective scales showing equal time intervals decrease as located closer to the end of the time axis, and increase as located closer to the center of the time axis.

6. A reproduction method comprising:
(a) reproducing audio and/or video data by an information processing device which includes an operation unit for receiving operation from a user;
(b) displaying a time axis and scales on the time axis and displays a reproduction position indicator indicating the current reproduction position of the audio and/or video data on the time axis by the information processing device;
(c) receiving operation for shifting the reproduction position indicator on the time axis by the operation unit of the information processing device; and
(d) detecting information concerning to shift received in the step (c) by the information processing device,
wherein
in case that operation for shifting the reproduction position indicator is received, the information processing device reproduces audio and/or video data at the reproduction position indicated by the reproduction position indicator after shift in the step (a), and
the information processing device changes time interval shown by a unit length between the scales on the time axis based on the shift information in the step of displaying the time axis and the scales.

7. A computer program product comprising instructions executable by a computer which includes an operation unit for receiving operation from a user, the computer program product being adapted for causing the computer to perform the functions of:
(a) reproducing audio and/or video data,
(b) displaying a time axis and scales on the time axis and displays a reproduction position indicator indicating the current reproduction position of the audio and/or video data on the time axis,
(c) receiving operation for shifting the reproduction position indicator on the time axis by the operation unit, and
(d) detecting information concerning to shift received in the step (c),
wherein
in case that operation for shifting the reproduction position indicator is received, audio and/or video data at the reproduction position indicated by the reproduction position indicator after shift is reproduced in the step of reproducing audio and/or video data, and
time interval shown by a unit length between the scales on the time axis is changed based on the shift information in the step (b).
